(19) United States
(12) Patent Application Publication
(10) Pub. No.: US 2024/0258640 A1
(43) Pub. Date: Aug. 1, 2024

(54) BATTERY MODULE COMPRISING VENTING HOLE AND BATTERY PACK COMPRISING THE SAME

(71) Applicant: SK On Co., Ltd., Seoul (KR)

(72) Inventors: Tae Il KIM, Daejeon (KR); Tae Hyeon KIM, Daejeon (KR); Eung Ho LEE, Daejeon (KR); Ju Young JEONG, Daejeon (KR)

(21) Appl. No.: 18/396,719

(22) Filed: Dec. 27, 2023

(30) Foreign Application Priority Data
Feb. 1, 2023 (KR) 10-2023-0013570

(51) Int. Cl. H01M 50/342; H01M 50/258; H01M 50/276; H01M 50/325

(52) U.S. Cl. CPC H01M 50/3425; H01M 50/258; H01M 50/276; H01M 50/325

(57) ABSTRACT

A battery module and a battery pack including the battery module are disclosed. The battery module includes a housing forming an accommodating space and a cell assembly disposed within the accommodating space and including a plurality of battery cells. The housing includes: an accommodating portion surrounding at least a portion of the cell assembly and a cover disposed in a first direction with respect to the accommodating portion and including a plurality of venting holes. The plurality of venting holes are configured to discharge gas in a second direction, different from the first direction, and the cover includes an upper surface and a plurality of protruding regions protruding from the upper surface in the first direction and surrounding at least some of the plurality of venting holes, respectively.

### CROSS-REFERENCE TO RELATED APPLICATIONS

This patent document claims the priority and benefits of Korean Patent Application No. 10-2023-0013570 filed on Feb. 1, 2023, the disclosure of which is incorporated herein by reference in its entirety.

### TECHNICAL FIELD

This document is relate to a battery module including a venting hole and a battery pack including the same. More particularly, the present disclosure is relate to a battery module including a cover with a venting hole and a battery pack including the same.

### BACKGROUND

Unlike primary batteries, secondary batteries may be charged with and discharged of electricity, so they may be applied to various fields, such as digital cameras, mobile phones, laptops, hybrid vehicles, electric vehicles, and energy storage systems (ESS). The secondary batteries may include a lithium ion battery, a nickel-cadmium battery, a nickel-metal hydride battery, or a nickel-hydrogen battery.

Secondary batteries are manufactured as flexible pouch-type battery cells or rigid prismatic or cylindrical can-type battery cells. A plurality of battery cells may be formed as a stacked cell assembly.

The cell assembly may be disposed inside a module housing to form a battery module, and a plurality of battery modules may be arranged inside a pack housing to form a battery pack.

### SUMMARY

The battery cell may be ignited when various events occur, such as when the lifespan of the battery cell reaches the end, when swelling occurs in the battery cell, when overcharging occurs in the battery cell, when the battery cell is exposed to heat, or when a sharp object, such as a nail, penetrates through the battery cell, or when external shock is applied to the battery cell. When a cell assembly including a battery cell ignites, flames or high-temperature gases (including electrolyte gas and combustion substances) emitted from the cell assembly may cause secondary ignition or chain ignition in other adjacent cell assemblies located within other battery modules. In addition, if flames occurring in a battery pack are exposed externally, other components around the battery pack may be damaged and secondary ignition (chain ignition) of other components may occur.

According to an aspect of the present disclosure, a battery module and a battery pack may be provided that can delay or prevent gas or flame generated in a cell assembly to another cell assembly or other components.

According to an aspect of the present disclosure, a battery module and a battery pack may be provided that can delay or prevent secondary ignition and/or thermal runaway phenomenon of a cell assembly.

The battery module and the battery pack of the present disclosure may be widely adopted in green technology fields, such as electric vehicles, battery charging stations, and other solar power generation and wind power generation using batteries. In addition, the battery module and battery pack of the present disclosure may be used in eco-friendly electric vehicles and hybrid vehicles to prevent a climate change by suppressing air pollution and greenhouse gas emissions.

A battery module of the present disclosure includes: a housing forming an accommodating space; and a cell assembly disposed within the accommodating space and including a plurality of battery cells. The housing includes: an accommodating portion surrounding at least a portion of the cell assembly; and a cover disposed in a first direction with respect to the accommodating portion and including a plurality of venting holes. The plurality of venting holes are configured to discharge gas in a second direction, different from the first direction, and the cover includes an upper surface and a plurality of protruding regions protruding from the upper surface in the first direction and surrounding at least some of the plurality of venting holes, respectively.

According to an embodiment of the present disclosure, at least some of the protruding regions may be configured to be opened with respect to the accommodating portion based on the gas occurring in the cell assembly.

According to an embodiment of the present disclosure, the plurality of protruding regions may be configured to be separated from the upper surface or bent with respect to the upper surface when a pressure inside the battery module is equal to or greater than a specified pressure.

According to an embodiment of the present disclosure, the second direction may be perpendicular to the first direction.

According to an embodiment of the present disclosure, at least some of the protruding regions may be configured to open at least a portion of the accommodating space, while rotating with respect to a sidewall member of the accommodating portion in a third direction, perpendicular to the first direction and the second direction, based on the gas occurring in the cell assembly.

According to an embodiment of the present disclosure, the plurality of venting holes may communicate with the accommodating space.

According to an embodiment of the present disclosure, the cover may include aluminum.

According to an embodiment of the present disclosure, the battery module may further include: a vent control member at least partially disposed in the venting hole and controlling whether to open the venting hole.

According to an embodiment of the present disclosure, the vent control member may be configured to block movement of fluid when the pressure inside the battery module is less than a first specified pressure, the vent control member may be configured to provide a first path allowing the gas to pass therethrough from an inside of the battery module to an outside of the battery module when the pressure inside the battery module is equal to or greater than the first specified pressure, and the cover may be configured to be opened with respect to the accommodating portion to provide a second path when the pressure inside the battery module is equal to or greater than a second specified pressure greater than the first specified pressure.

According to an embodiment of the present disclosure, a cross-sectional area of the second path may be greater than a cross-sectional area of the first path.

According to an embodiment of the present disclosure, the vent control member may include a rupture plate or valve.

A battery module of the present disclosure includes: a housing forming an accommodating space; and a cell assembly disposed within the accommodating space and including a plurality of battery cells. The housing includes: an accommodating portion surrounding at least a portion of the cell assembly; and a cover disposed on the accommodating portion and including a plurality of venting holes. At least a portion of the cover adjacent to the venting hole is configured to be opened with respect to the accommodating portion based on a gas occurring in the cell assembly.

According to an embodiment of the present disclosure, the venting hole may include a first region and at least one second region, perpendicular to the first region, and the cover may include a bendable region at least partially surrounded by the first region and the at least one second region and configured to be bent when pressure inside the battery module is equal to or greater than a specified pressure.

According to an embodiment of the present disclosure, the cover may include an upper surface and a plurality of protruding regions protruding from the upper surface and surrounding at least some of the plurality of venting holes, respectively, wherein the plurality of protruding regions may be configured to be separated from the upper surface or bent with respect to the upper surface when the pressure inside the battery module is equal to or greater than a specified pressure.

A battery pack of the present disclosure includes: a pack housing; and a plurality of battery modules accommodated within the pack housing, wherein each of the plurality of battery modules includes: a housing forming an accommodating space; and a cell assembly disposed within the accommodating space and including a plurality of battery cells. The housing includes: an accommodating portion surrounding at least a portion of the cell assembly; and a cover disposed in a first direction with respect to the accommodating portion and including a plurality of venting holes. The plurality of venting holes are configured to discharge gas in a second direction, different from the first direction, and the cover includes an upper surface and a plurality of protruding regions protruding from the upper surface in the first direction and surrounding at least some of the plurality of venting holes, respectively. At least some of the plurality of protruding regions are configured to be opened with respect to the accommodating portion based on the bas occurring in the cell assembly.

### BRIEF DESCRIPTION OF DRAWINGS

Certain aspects, features, and advantages of the disclosed technology are illustrated by the following detailed description with reference to the accompanying drawings.

FIG. 1 is a perspective view of a battery cell, according to an embodiment in the present disclosure;

FIG. 2 is a perspective view of a battery module, according to an embodiment in the present disclosure;

FIG. 3 is an exploded perspective view of a battery module, according to an embodiment in the present disclosure;

FIG. 4 is an enlarged view of region A of FIG. 2, according to an embodiment in the present disclosure;

FIG. 5A is a schematic diagram of a battery module in a first pressure state, according to an embodiment in the present disclosure;

FIG. 5B is a schematic diagram of a battery module in a second pressure state, according to an embodiment in the present disclosure;

FIG. 6 is a perspective view of a battery module, according to an embodiment in the present disclosure; and

FIG. 7 is a perspective view of a battery pack, according to an embodiment in the present disclosure.

### DETAILED DESCRIPTION

The present disclosure will be described in detail with reference to the accompanying drawings. However, this is merely illustrative and the present disclosure is not limited to the specific exemplary embodiments described by way of example.

Terms and words used in the present specification and claims to be described below should not be construed as limited to ordinary or dictionary terms, and should be construed in accordance with the technical idea of the present disclosure based on the principle that the inventors may properly define their own inventions in terms of terms in order to best explain the invention.

Therefore, the exemplary embodiments described in the present specification and the configurations illustrated in the drawings are merely the most preferred exemplary embodiments of the present disclosure and are not intended to represent all of the technical ideas of the present disclosure, and thus should be understood that various equivalents and modifications may be substituted at the time of the present application.

Hereinafter, exemplary embodiments of the present disclosure will be described in detail with reference to the accompanying drawings. In this case, in the drawings, the same components are denoted by the same reference symbols as possible. Further, the detailed description of well-known functions and constructions which may obscure the gist of the present disclosure will be omitted. Some of the elements in the accompanying drawings are exaggerated, omitted, or schematically illustrated, and the size of each element does not entirely reflect the actual size.

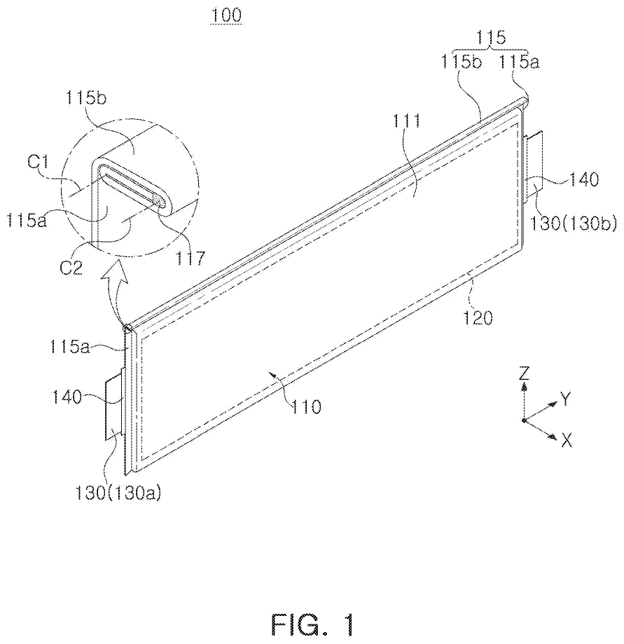

FIG. 1 is a perspective view of a battery cell, according to an embodiment in the present disclosure.

Referring to FIG. 1, a battery cell 100 may include a pouch 110, an electrode assembly 120, and an electrode lead 130. The battery cell 100 may be a secondary battery. For example, the battery cell 100 may be a lithium ion battery, but is not limited thereto. For example, the battery cell 100 may be a nickel-cadmium electric battery, a nickel-metal hydride battery, or a nickel-hydrogen battery that may be charged and discharged.

The battery cell 100 may be a pouch-type secondary battery. However, the battery cell 100 is not limited to the pouch-type secondary battery. For example, in another embodiment, the battery cell 100 may be a prismatic secondary battery or a cylindrical secondary battery.

The pouch 110 may form at least a portion of the exterior of the battery cell 100. The pouch 110 may include an electrode accommodating portion 111 accommodating the electrode assembly 120 and a sealing portion 115 sealing at least a portion of the circumference of the electrode accommodating portion 111. The electrode accommodating portion 111 may provide a space to accommodate the electrode assembly 120 and the electrolyte solution.

The sealing portion 115 may be formed by joining at least a portion of the circumference of the pouch 110. The sealing portion 115 may be formed in the form of a flange extending outwardly from the electrode accommodating portion 111 formed in the shape of a container and may be disposed along at least a portion of an outer portion of the electrode accommodating portion 111. In an embodiment, the sealing portion 115 may include a first sealing portion 115a in which the electrode lead 130 is located and a second sealing portion 115b in which the electrode lead 130 is not located. A portion of the electrode lead 130 may be drawn out or exposed to the outside of the pouch 110. In order to increase sealability of the first sealing portion 115a and at the same time ensure an electrical insulation state in a position in which the electrode lead 130 is drawn out, the electrode lead 130 is covered by an insulating film 140. The insulating film 140 is formed of a film material thinner than the electrode lead 130 and may be attached to both sides of the electrode lead 130.

In an embodiment, the electrode leads 130 may be disposed on both sides of the battery cell 100 in a length direction (a Y-axis direction) to face in opposite directions. For example, the electrode lead 130 may include a positive lead 130a having a first polarity (e.g., a positive electrode) facing one side of the battery cell 100 in the length direction and a negative lead 130b having a second polarity (e.g., a negative electrode) facing the other side of the battery cell 100 in the length direction. In the embodiment shown in FIG. 1, the sealing portion 115 may include two first sealing portions 115a in which the electrode lead 130 is disposed and one second sealing portion 115b in which the electrode lead 130 is not disposed.

The direction in which the electrode lead 130 is located may be selectively designed. In an embodiment (e.g., FIG. 1), the electrode lead 130 may include the positive electrode lead 130a and the negative electrode lead 130b located in the opposite direction of the positive lead 130a with respect to the electrode assembly 120. In FIG. 1, although the electrode leads 130 are illustrated to be disposed to face in the opposite directions on both sides of the battery cell 100 in the length direction (e.g., the Y-axis direction), the structure of the electrode leads 130 is not limited thereto. For example, the two electrode leads 130 may be arranged to be substantially in parallel in the length direction (e.g., the Y-axis direction) of the battery cell 100.

Meanwhile, the pouch 110 is not limited to a structure in which the sealing portion 115 is formed on three sides of a single folded outer case as shown in FIG. 1.

In an embodiment in the present disclosure, at least a portion of the sealing portion 115 may be formed to be folded at least once. Since at least a portion of the sealing portion 115 is folded, bonding reliability of the sealing portion 115 may be improved and the area of the sealing portion 115 may be minimized. Among the sealing portions 115 according to an embodiment, the second sealing portion 115b in which the electrode lead 130 is not disposed may be folded twice and then fixed by an adhesive member 117. For example, the second sealing portion 115b may be folded 180° along a first bend line C1 and then folded again along a second bend line C2. At this time, the inside of the second sealing portion 115b may be filled with the adhesive member 117.

The electrode assembly 120 may include a cathode plate, an anode plate, and a separator.

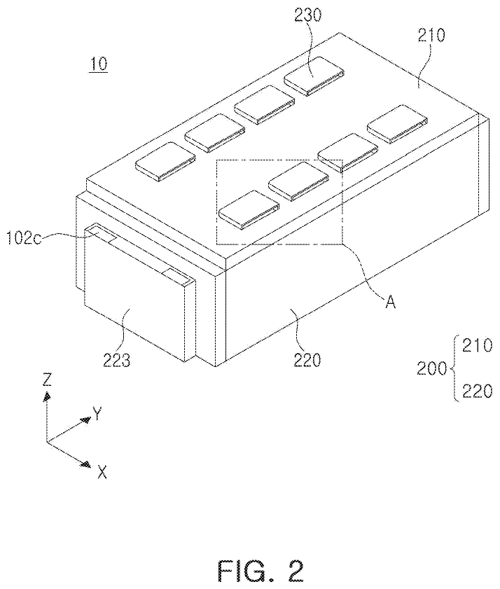

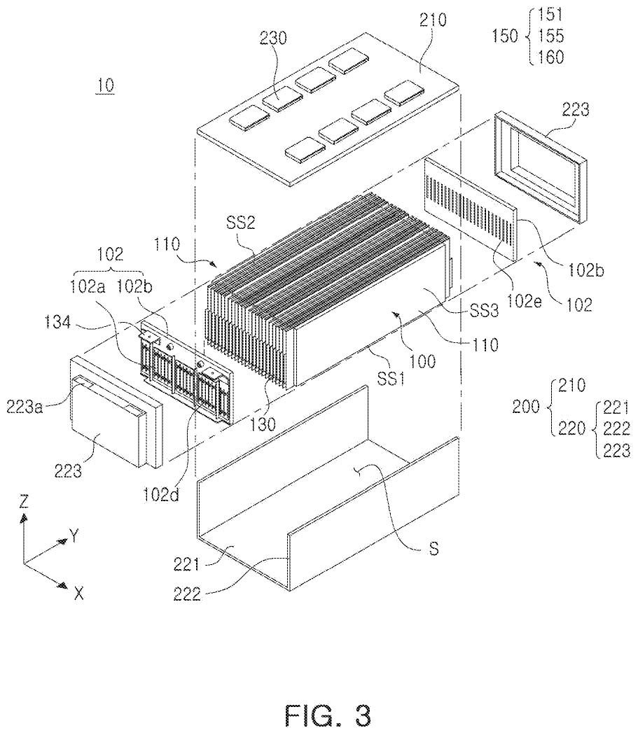

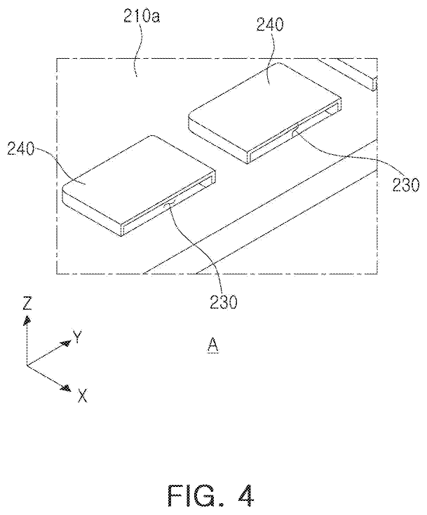

FIG. 2 is a perspective view of a battery module, according to an embodiment in the present disclosure. FIG. 3 is an exploded perspective view of a battery module, according to an embodiment in the present disclosure. FIG. 4 is an enlarged view of area A of FIG. 2, according to an embodiment in the present disclosure.

Referring to FIGS. 2, 3, and/or 4, the battery module 10 may include a cell assembly 101, a busbar assembly 102, and a housing 200. The cell assembly 101 may include a plurality of battery cells 100. The description of the battery cell 100 in FIG. 1 may be applied to the battery cell 100 in FIG. 3.

The cell assembly 101 may have a substantially hexahedral shape. For example, the cell assembly 101 may be formed as a hexahedron having a lower surface SS1, an upper surface SS2, and four side surfaces SS3 connecting the lower surface SS1 to the upper surface SS2. In an embodiment, the cell assembly 101 may be referred to as a cell stack.

The busbar assembly 102 may include an electrically conductive busbar 102a electrically connected to the electrode lead 130 of the battery cell 100 and an electrically insulating support plate 102b. The support plate 102b may be disposed between the cell assembly 101 and the busbar 102a to support the busbar 102a. The electrode lead 130 may pass through a through-hole 102e of the support plate 102b and then be connected to a slit 102d of the busbar 102a.

The busbar assembly 102 may include at least one connection terminal 102c for electrical connection to the outside. The electrode lead 130 of the battery cell 100 may be electrically connected to the outside of the battery module 10 through the connection terminal 102c. For example, the connection terminal 102c may be connected to the busbar 102a through a wire (not shown), and current of the battery cell 100 may pass through the busbar 102a and the connection terminal 102c to be transmitted to the outside of the battery module 10. The connection terminal 102c may be exposed to the outside of the housing 200 through a hole 223a of an end plate 223.

The housing 200 may form an accommodating space S accommodating the cell assembly 101 and/or the busbar assembly 102. For example, the housing 200 may include a cover 210 covering the upper surface SS2 of the cell assembly 101 and an accommodating portion 220 surrounding the lower surface SS1 and side surface SS3 of the cell assembly 101. At least a portion of the accommodating space S may be surrounded by a main plate 221, a sidewall member 222, and the end plate 223.

The housing 200 may be formed of a material having high thermal conductivity, such as metal. For example, housing 200 may be formed of aluminum. However, the material of the housing 200 is not limited thereto.

The cover 210 may be formed of a bendable material. For example, cover 210 may include aluminum.

The accommodating portion 220 may include a main plate 221 covering the lower surface SS1 of the cell assembly 101 and a plurality of sidewall members 222 covering at least a portion of the side surface SS3 of the cell assembly 101.

The accommodating portion 220 may include the end plate 223 covering a portion of the side surface SS3 of the cell assembly 101. In an embodiment, the end plate 223 may be connected to both ends of the main plate 221 and the sidewall member 222 in a second direction (the length direction) (the Y-axis direction). The end plate 223 may cover a portion of the side surface SS3 of the cell assembly 101 and the busbar assembly 102. The end plate 223 may include a hole 223a accommodating the electrode lead 130.

The cover 210 may include at least one venting hole 230 discharging flames and/or gas occurring in the battery cell 100 of the cell assembly 101 to the outside of the housing 200. The venting hole 230 may be referred to as a flow path, an outlet, or a through-hole. As flames and/or gas are discharged to the outside of the battery module 10 through the venting hole 230, an increase in pressure inside the battery module 10 may be reduced. The venting hole 230 may communicate with the accommodating space S formed by the housing 200. For example, the venting hole 230 may be used as a path for discharging gas inside the accommodating space S to the outside of the housing 200.

The cover 210 may emit flames and/or gas in a specified direction using the venting hole 230. For example, the cover 210 may be located above the accommodating portion 220 (e.g., in a first direction (a +Z-direction)). The venting hole 230 may induce the discharge of flames and/or gas in the second direction, different from the first direction. In an embodiment, the second direction may be a direction (e.g., a +X-direction), substantially perpendicular to the first direction.

The cover 210 may include an upper surface 210a facing the outside of the battery module 10 and at least one protruding region 240 protruding from the upper surface 210a. The protruding region 240 may form at least a portion of the venting hole 230. For example, at least a portion of the venting hole 230 may be surrounded by the protruding region 240. In an embodiment, the plurality of protruding regions 240 may each form the venting hole 230 for discharging gas in a specified direction (e.g., the second direction (+X direction)).

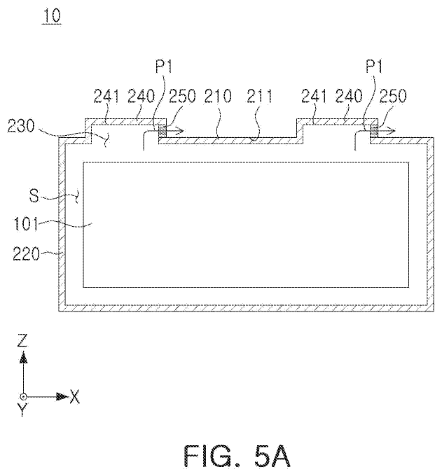

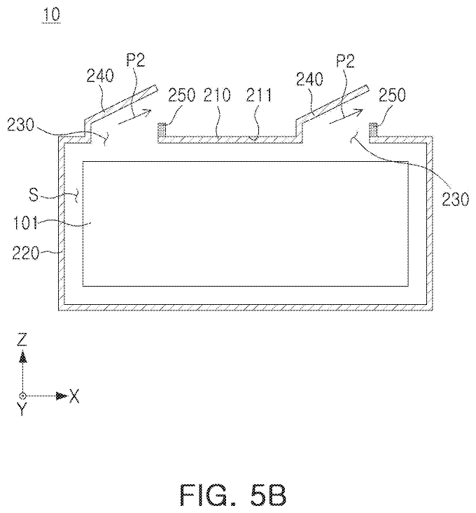

FIG. 5A is a schematic diagram of a battery module in a first pressure state, according to an embodiment in the present disclosure. FIG. 5B is a schematic diagram of a battery module in a second pressure state, according to an embodiment in the present disclosure.

Referring to FIGS. 5A and/or 5B, the battery module 10 may include the cell assembly 101 and the housing 200. The housing 200 may include the cover 210 in which the venting hole 230 is formed. Descriptions of the battery module 10, the cell assembly 101, the housing 200, the cover 210, the venting hole 230, and/or the protruding region 240 of FIGS. 2, 3, and/or 4 may be applied to the battery module 10, the cell assembly 101, the housing 200, the cover 210, the venting hole 230, and/or the protruding region 240 of FIGS. 5A and/or 5B. In FIGS. 5A and 5B, some components (e.g., the busbar assembly 102 of FIG. 3) are omitted for convenience of description, but, obviously, a person skilled in the art may apply the omitted components to the battery module 10.

According to an embodiment, at least a portion of the cover 210 may be opened based on internal pressure of the housing 200. For example, the protruding region 240 may be separated from or bent with respect to the upper surface 211 of the cover 210. According to an embodiment, at least some of the protruding regions 240 may be opened with respect to the accommodating portion 220 based on gas and/or flames generated in the cell assembly 101. For example, when pressure received by a lower surface 241 of the protruding region 240 is greater than a specified pressure, at least some of the protruding regions 240 may be separated from the upper surface 211 of the cover 210.

Referring to FIG. 5A, when pressure inside the housing 200 is in the first pressure state, a fluid inside the battery module 10 may pass through the venting hole 230 and be delivered to the outside of the battery module 10. For example, in the first pressure state, the fluid inside the battery module 10 may be discharged to the outside of the battery module 10 through a first path P1 defined by the venting hole 230. The first pressure state may be a state in which the pressure inside the battery module 10 is less than a specified pressure. For example, the first pressure state may be a state in which no gas and/or flames occur in the cell assembly 101 or a state in which the pressure inside the battery module 10 does not reach a specified pressure (e.g., a second specified pressure) after the cell assembly 101 is ignited.

Referring to FIG. 5B, when the pressure inside the housing 200 is in the second pressure state, the protruding region 240 of the cover 210 may be opened with respect to the accommodating portion 220 based on the flames and/or gas occurring in the cell assembly 101. In an embodiment, the flames occurring in the cell assembly 101 may pass through a second path P2 defined by a space between the open protruding region 240 and the cover 210 and be discharged to the outside of the housing 200. In an embodiment, at least a portion of the cover 210 may be rotatably connected to the accommodating portion 220. When flames and/or gas are discharged from the venting hole 230, at least a portion of the cover 210 may be separated with respect to the accommodating portion 220. At least a portion of the cover 210 may rotate with respect to the accommodating portion 220 in a third direction (the Y-axis direction) when flames and/or gas are discharged from the venting hole 230. For example, at least a portion (e.g., the protruding region 240) of the cover 210 may rotate with respect to the sidewall member 222 of the accommodating portion 220 in the third direction to open the accommodating space S.

In an embodiment, a cross-sectional area and/or volume of the second path P2 may be greater than a cross-sectional area and/or volume of the first path P1. By increasing the area in which flames and/or gas are discharged from the battery module 10, flame transfer to other adjacent battery modules 10 may be reduced.

Since the cover 210 is opened, other battery modules adjacent to the battery module 10 from which flames and/or gas are discharged may be protected. For example, the flames and/or gas occurring in the cell assembly 101 may be discharged to the outside of the battery module 10 through the venting hole 230 and the space between the opened cover 210 and the accommodating portion 220. As the flames and/or gases are discharged in an intended direction, the amount of flames and/or gas transmitted to other adjacent battery modules 10 may be reduced.

According to an embodiment, the pressure inside the battery module 10 may be increased by gas occurring in the electrode assembly (e.g., the electrode assembly 120 of FIG. 1) of the battery cell (e.g., the battery cell 100 of FIG. 1). When the pressure inside the battery module 10 reaches a specified pressure, at least a portion of the cover 210 may be opened. As gas is discharged through the venting hole 230, a pressure change rate of the battery module 10 may be reduced and a heat transfer phenomenon may be delayed or reduced.

According to an embodiment, the cover 210 may include a vent control member 250 for controlling whether to open the venting hole 230. For example, the vent control member 250 may include a rupture plate for controlling whether to open the venting hole 230. At least a portion of the rupture plate may be disposed within the venting hole 230. According to an embodiment, the rupture plate may rupture when the pressure inside the battery module 10 is equal to or higher than a set pressure. When the rupture plate breaks, venting hole 230 may be opened. As another example, the vent control member 250 may include a valve. For example, the vent control member 250 including a one-way valve may allow fluid to pass from the inside to the outside of the battery module 10 therethrough, while preventing movement of fluid from the outside to the inside of the battery module 10. The vent control member 250 may be selectively installed in the battery module 10 depending on the design of the battery module 10.

According to an embodiment, the vent control member 250 may be interpreted as part of the protruding region 240. For example, opening or closing the vent control member 250 may be referred to as opening or closing the protruding region 240. According to an embodiment (not shown), the vent control member 250 may be connected to the protruding region 240 and may be opened together with the protruding region 240 when the protruding region 240 is opened with respect to the accommodating portion 220.

According to an embodiment, the area in which gas and/or flames inside the battery module 10 are discharged may change by stages depending on the pressure inside the battery module 10. For example, the battery module 10 may 10 may include the vent control member 250 allowing fluid (e.g., gas and/or flames) to move when the pressure inside battery module 10 is equal to or greater than a first specified pressure. When the pressure inside the battery module 10 is less than the first specified pressure, the vent control member 250 may block the movement of fluid, and accordingly, the movement of fluid inside the battery module 10 to the outside of the battery module 10 may be prevented. When the pressure inside the battery module 10 is equal to or greater than the first specified pressure and less than the second specified pressure greater than the first specified pressure, the fluid inside the battery module 10 may be discharged to the outside of the battery module 10 through the first path P1 formed by the venting hole 230. When the pressure inside the battery module 10 is equal to or greater than the second specified pressure, the cover 210 may be opened with respect to the accommodating portion 220 to provide the second path P2. The fluid inside the battery module 10 may be discharged to the outside of the battery module 10 through the second path P2 formed between the opened protruding region 240 and the cover 210. As the gas and/or flames occurring in the cell assembly 101 are discharged by stages, noise and/or vibrations due to a rapid changed in pressure may be reduced.

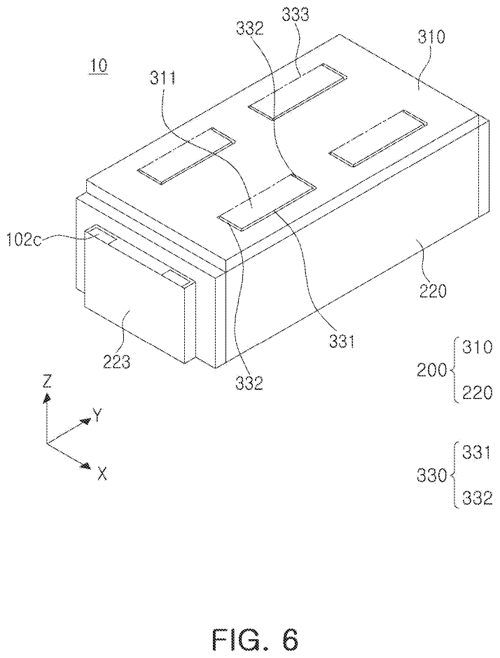

FIG. 6 is a perspective view of a battery module, according to an embodiment in the present disclosure.

Referring to FIG. 6, the battery module 10 may include the housing 200 including a cover 310.

The battery module 10 of FIG. 6 may include the cover 310 including a venting hole 330. The configuration of the battery module 10 except for the cover 310 and venting hole 330 in FIG. 6 may be the same in whole or in portion as the configuration of the battery module 10 illustrated in FIG. 2. For example, at least portion of the description of the connection terminal 102c, the cover 210, the accommodating portion 220, and/or the venting hole 230 in FIG. 2 may be applied to the connection terminal 102c, the cover 310, the accommodating portion 220 and/or the venting hole 330 of FIG. 6.

According to an embodiment, the venting hole 330 may be a slit or a through-hole formed in the cover 310.

According to an embodiment, the venting hole 330 may be formed in a shape for bending at least a portion (e.g., a bendable region 311) of the cover 310. For example, the venting hole 330 may surround a portion of the bendable region 311.

In an embodiment, the venting hole 330 may include a first region 331 and at least one second region 332, substantially perpendicular to the first region 331. The first region 331 and the second region 332 may surround the bendable region 311. The first region 331 may be located to be substantially parallel to a bending portion 333. According to an embodiment, the venting hole 330 may have a notch shape. The shape of the venting hole 330 may be selectively designed if the bendable region 311 may be bent.

When the pressure inside the battery module 10 is greater than a specified pressure, at least a portion (e.g., the bendable region 311) of the cover 310 may be bent with respect to the bending portion 333. For example, when a lower portion of the bendable region 311 receives pressure by gas and/or flames occurring in the cell assembly (e.g., the cell assembly 101 of FIG. 2) located inside the battery module 10, the bendable region 311 may rotate with respect to the bending portion 333 by the pressure. As the cover 310 is opened by the pressure, flames and/or gas may be discharged from the battery module 10 in an intended direction, and the amount of flames and/or gas transmitted to other adjacent battery modules 10 may be reduced.

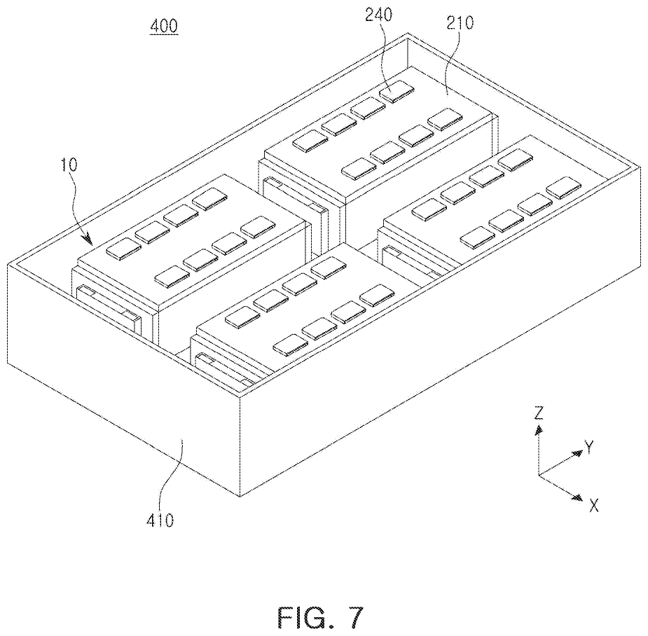

FIG. 7 is a perspective view of a battery pack, according to an embodiment in the present disclosure.

Referring to FIG. 7, a battery pack 400 may include a plurality of battery modules 10 and a pack housing 410 accommodating the plurality of battery modules 10. The description of the battery module 10 given above may be applied to the battery module 10 of FIG. 7. For example, the configuration of the cover 210 and the protruding region 240 in FIG. 2 may be the same in whole or in portion as the configuration of the cover 210 and the protruding region 240 in FIG. 7. According to an embodiment (not shown), the battery pack 400 may include the battery module 10 of FIG. 6 and the pack housing 410. According to an embodiment, the pack housing 410 may include a partition (not shown) to separate the battery module 10, depending on the design.

The number of battery modules 10 included in the battery pack 400 may be selectively changed depending on the design of the battery pack 400. For example, in the present disclosure, the battery pack 400 is shown as a structure including four battery modules 10, but the battery pack 400 may include more than four battery modules 10.

The battery module 10 may discharge flames and/or gas in a specified direction when the pressure inside the battery module 10 is greater than or equal to a specified pressure. As flames and/or gas are discharged in a specified direction, flame spread to other battery modules 10 located inside the battery pack 400 may be reduced. In addition, as flames and/or gas are discharged in a specified direction, damage to other components around the battery pack 400 may be reduced or prevented.

According to an embodiment in the present disclosure, the influence of gas or flames occurring in the cell assembly located within the battery module on other battery modules may be reduced or prevented.

According to an embodiment in the present disclosure, secondary ignition and/or thermal runaway phenomenon of the cell assembly may be delayed or prevented.

Only specific examples of implementations of certain embodiments are described. Variations, improvements and enhancements of the disclosed embodiments and other embodiments may be made based on the disclosure of this patent document.

What is claimed is:

1. A battery module comprising:
a housing forming an accommodating space; and
a cell assembly disposed within the accommodating space and including a plurality of battery cells,
wherein the housing includes:
an accommodating portion surrounding at least a portion of the cell assembly; and
a cover disposed in a first direction with respect to the accommodating portion and including a plurality of venting holes,
wherein the plurality of venting holes are configured to discharge gas in a second direction, different from the first direction, and
the cover includes an upper surface and a plurality of protruding regions protruding from the upper surface in the first direction and surrounding at least some of the plurality of venting holes, respectively.

2. The battery module of claim 1, wherein
at least some of the protruding regions are configured to be opened with respect to the accommodating portion based on the gas occurring in the cell assembly.

3. The battery module of claim 1, wherein
the plurality of protruding regions are configured to be separated from the upper surface or bent with respect to the upper surface when a pressure inside the battery module is equal to or greater than a specified pressure.

4. The battery module of claim 1, wherein
the second direction is perpendicular to the first direction.

5. The battery module of claim 1, wherein
at least some of the protruding regions are configured to open at least a portion of the accommodating space, while rotating with respect to a sidewall member of the accommodating portion in a third direction, perpendicular to the first direction and the second direction, based on the gas occurring in the cell assembly.

6. The battery module of claim 1, wherein
the plurality of venting holes communicate with the accommodating space.

7. The battery module of claim 1, wherein
the cover includes aluminum.

8. The battery module of claim 1, further comprising:
a vent control member at least partially disposed in the venting hole and configured to control whether to open the venting hole.

9. The battery module of claim 8, wherein
the vent control member is configured to block movement of fluid when the pressure inside the battery module is less than a first specified pressure,
the vent control member is configured to provide a first path allowing the gas to pass therethrough from an inside of the battery module to an outside of the battery module when the pressure inside the battery module is equal to or greater than the first specified pressure, and
the cover is configured to be opened with respect to the accommodating portion to provide a second path when the pressure inside the battery module is equal to or greater than a second specified pressure greater than the first specified pressure.

10. The battery module of claim 9, wherein
a cross-sectional area of the second path is greater than a cross-sectional area of the first path.

11. The battery module of claim 1, wherein
the vent control member includes a rupture plate or valve.

12. A battery module comprising:
a housing forming an accommodating space; and
a cell assembly disposed within the accommodating space and including a plurality of battery cells,
wherein the housing includes:
an accommodating portion surrounding at least a portion of the cell assembly; and
a cover disposed on the accommodating portion and including a plurality of venting holes,
wherein at least a portion of the cover adjacent to the venting hole is configured to be opened with respect to the accommodating portion based on a gas occurring in the cell assembly.

13. The battery module of claim 12, wherein
the venting hole includes a first region and at least one second region, perpendicular to the first region, and
the cover includes a bendable region at least partially surrounded by the first region and the at least one second region and configured to be bent when pressure inside the battery module is equal to or greater than a specified pressure.

14. The battery module of claim 12, wherein
the cover includes an upper surface and a plurality of protruding regions protruding from the upper surface and surrounding at least some of the plurality of venting holes, respectively,
wherein the plurality of protruding regions are configured to be separated from the upper surface or bent with respect to the upper surface when the pressure inside the battery module is equal to or greater than a specified pressure.

15. A battery pack comprising:
a pack housing; and
a plurality of battery modules accommodated within the pack housing,
wherein each of the plurality of battery modules includes:
a housing forming an accommodating space; and
a cell assembly disposed within the accommodating space and including a plurality of battery cells,
wherein the housing includes:
an accommodating portion surrounding at least a portion of the cell assembly; and
a cover disposed in a first direction with respect to the accommodating portion and including a plurality of venting holes,
wherein the plurality of venting holes are configured to discharge gas in a second direction, different from the first direction, and
the cover includes an upper surface and a plurality of protruding regions protruding from the upper surface in the first direction and surrounding at least some of the plurality of venting holes, respectively,
wherein at least some of the plurality of protruding regions are configured to be opened with respect to the accommodating portion based on the bas occurring in the cell assembly.
